(19) United States
(12) Patent Application Publication
(10) Pub. No.: US 2026/0155126 A1
(43) Pub. Date: Jun. 4, 2026

(54) BELL RESONATOR DEVICE, SYSTEM, AND METHOD

(71) Applicant: The Regents of the University of Michigan, Ann Arbor, MI (US)

(72) Inventors: Julie J. ZHU, Ann Arbor, MI (US); Lauro Ojeda, Ann Arbor, MI (US); Jonathan E. Luntz, Ann Arbor, MI (US); Connor LaBo, Ann Arbor, MI (US); Michael Wynn, Ann Arbor, MI (US); Nicholas Bush, Ann Arbor, MI (US); Ahmed Wasif, Ann Arbor, MI (US)

(21) Appl. No.: 19/409,526

(22) Filed: Dec. 4, 2025

Related U.S. Application Data
(60) Provisional application No. 63/728,154, filed on Dec. 4, 2024.

(51) Int. Cl. G10K 1/064

(52) U.S. Cl. CPC G10K 1/064

(57) ABSTRACT

A bell resonator, a bell resonator system, and method of producing sound from a bell are provided. The bell resonator system includes the bell resonator, and the bell resonator includes a piezoelectric transducer and a mounting device. The mounting device supports the piezoelectric transducer and is configured to attach to a bell such that the piezoelectric transducer engages a surface of the bell so as to vibrate the bell when the piezoelectric transducer is electrically activated. The method includes attaching a bell resonator to a bowl of the bell; and causing the bell resonator to vibrate the bell by electrical excitation of a transducer of the bell resonator that is in contact with a surface of the bell.

### TECHNICAL FIELD

This disclosure relates to a resonator device, system, and method for a bell, such as a bell of a carillon.

### BACKGROUND

Carillons are musical instruments consisting of suspended bells connected to a keyboard via a pulley mechanism. The player uses their first and feet to play the instrument. A traditional carillon has 23 or more bells and a grand carillon has 50 or more bells. The North Campus Bell Tower in Ann Arbor, Michigan has 60 bells and is one of 23 grand carillons in the world. These bells go through regular maintenance every year. However, carillons are usually tuned every 300 years. The bells of the North Campus Bell Tower are numbered from 0 to 60 and skip No. 1. Bell No. 0 is the heaviest and No. 60 is the lightest. The No. 1 bell would have been the second largest bell, but it would have been a note that is rarely played. So, from a space and budget perspective, it was skipped. The exact mass of these bells is kept secret by the manufacturers, but these bells weigh up to 6 tons. Depending on the bell size, there are three tiers of bells in the tower. Bell numbers 27 to 60 fall under the third tier.

The bells are rigidly mounted to the wall at the top with a headpiece that goes through the bore of the bell. The clapper is connected to the headpiece with a pin joint (clapper pin) and a rigid rod (clapper stem). The clapper is then connected to the wooden keyboard via a series of cables, pulleys, and other mechanical linkage systems. The keyboard is also connected to an adjustable turnbuckle that moves the clapper closer to or farther away from the bell. Some smaller bells also have a torsional spring that returns the clapper to its original position after a hit.

To sustain the tone, a labor-intensive tremolo technique is required, where the player repeatedly hits the bell to counter the sound decay rate, causing physical strain and limiting the musical innovation capabilities. The bells are played with clappers that are connected to two large keyboards through a system of steel cables and pulleys. The composer uses their fists and feet to play the bells. The amplitude of a ringing bell naturally decays over time. If a composer wants the bells to ring longer, the bell must be struck continuously by the clapper, which puts physical strain on their body, reduces the number of keys they can play, and limits their musical creativity.

Additionally, the players cannot create a smooth continuous sound as the repeated striking of the clapper on the bell creates a distinctive sound with each impact, disturbing rhythm. In convention carillons, a notable problem is to sustain a continuous tone of the bells indefinitely.

### SUMMARY

In accordance with a first aspect of the invention, there is provided a bell resonator for a bell. The bell resonator includes a piezoelectric transducer and a mounting device. The mounting device supports the piezoelectric transducer and is configured to attach to a bell such that the piezoelectric transducer engages a surface of the bell so as to vibrate the bell when the piezoelectric transducer is electrically activated.

According to various embodiments of the first aspect of the invention, the bell resonator further includes any one of the following features or any technically-feasible combination of some or all of these features:
the mounting device comprises a clamp configured to attach to the bell using at least three points of contact that include at least one inside surface of the bell and at least one outside surface of the bell;
the clamp includes at least three finger grips that attach the clamp to the bell at the at least three points of contact;
the clamp includes an elastomeric contact surface at a distal end of each of the three or more finger grips;
the clamp further comprises a spring-biased pivot connection between at least two of the finger grips;
the bell resonator further comprises an adjustable transducer positioner that connects the piezoelectric transducer to the mounting device;
the clamp attaches over a bottom lip of the bell; and/or
the bell resonator further comprises a second piezoelectric transducer carried by the mounting device such that both piezoelectric transducers engage a surface of the bell so as to vibrate the bell when the piezoelectric transducers are electrically activated.

In accordance with a second aspect of the invention, there is provided a bell resonator system. The bell resonator system includes the bell resonator of the first aspect of the invention.

According to various embodiments of the second aspect of the invention, the bell resonator system includes any one of the foregoing features or any technically-feasible combination of some or all of the features discussed in connection with the bell resonator of the first aspect of the invention.

In accordance with a third aspect of the invention, there is provided a method of producing sound from a bell. The method includes: attaching a bell resonator to a bowl of the bell; and causing the bell resonator to vibrate the bell by electrical excitation of a transducer of the bell resonator that is in contact with a surface of the bell. According to an embodiment, the transducer is a piezoelectric transducer.

According to various embodiments of the third aspect of the invention, the bell resonator includes any one of the foregoing features or any technically-feasible combination of some or all of the features discussed in connection with the bell resonator of the first aspect of the invention.

### BRIEF DESCRIPTION OF THE DRAWINGS

Preferred exemplary embodiments will hereinafter be described in conjunction with the appended drawings, wherein like designations denote like elements, and wherein:

FIG. 1 is a perspective, sectional view of a bell and a bell resonator for the bell, according to one embodiment;

FIG. 2 is a perspective view of the bell resonator of FIG. 1, according to one embodiment;

FIG. 3 is a diagrammatic depiction illustrating stabilization of a mounting device to a bell through use of three contact points, according to one embodiment;

FIGS. 4-5 are diagrammatic depictions illustrating torsional forces or moment resulting from a mounting device having only two contact points on a bell;

FIG. 6 depicts a bell resonator system comprising the bell resonator of FIG. 1 and excitation circuitry, according to one embodiment;

FIG. 7 depicts excitation circuitry that may be used as a part of the bell resonator system of FIG. 6, according to one embodiment;

FIG. 8 depicts frequency zones of a bell, which may be the bell of FIG. 1, according to one embodiment;

FIG. 9 depicts a bell resonator system comprising the bell resonator of FIG. 1, excitation circuitry, and another bell resonator, according to one embodiment;

FIG. 10 depicts a bell resonator having a distributed piezo band design, according to one embodiment;

FIG. 11 is a flowchart illustrating a method of producing sound from a bell, such as through use of the bell resonator described in connection with FIGS. 1, 2, and/or 10, according to one embodiment; and

FIGS. 12-17 show various alternative embodiments of a mounting device that may be used for a bell resonator constructed in accordance with the invention.

### DETAILED DESCRIPTION

There is provided a bell resonator for a bell, such as a bell of a carillon, and a method of producing sound from a bell using a bell resonator. At least according to some embodiments, the bell resonator includes a piezoelectric transducer and a mounting device that supports the piezoelectric transducer and is configured to attach to the bell such that the piezoelectric transducer engages a surface of the bell so as to vibrate the bell when the transducer is electrically activated. According to embodiments, the bell resonator and method excite resonance on the bell and sustain its tone indefinitely or at least for a prolonged period.

According to an embodiment, there is also provided a bell resonator system incorporating the bell resonator and configured as a reliable, automated system that can excite the resonance and sustain the tone of an individual carillon bell indefinitely to reduce physical strain and enhance performance versatility. According to embodiments, the bell resonator, bell resonator system, and method described herein are used for exciting and sustaining resonance on carillon bells, such as, for example, the third tier bells, named bell Nos. 27 to 60 in the Lurie Carillon Bell Tower located in Ann Arbor, Michigan. The bell resonator includes, at least in embodiments, a circuit having a microcontroller, op amp chip, and boost module (as part of an “excitation circuit”) such that an analog signal may be applied and used for driving the piezoelectric transducers attached to the bell.

In some implementations, an automated playing system utilizing an external hammer to hit the bells using a solenoid may be used in addition to the bell resonator described herein. The solenoid acts as a motorized striker, actuating the hammer when current is applied. The automated system can play any song by controlling the current and timing of the hit and mimic the manual action of the carillon.

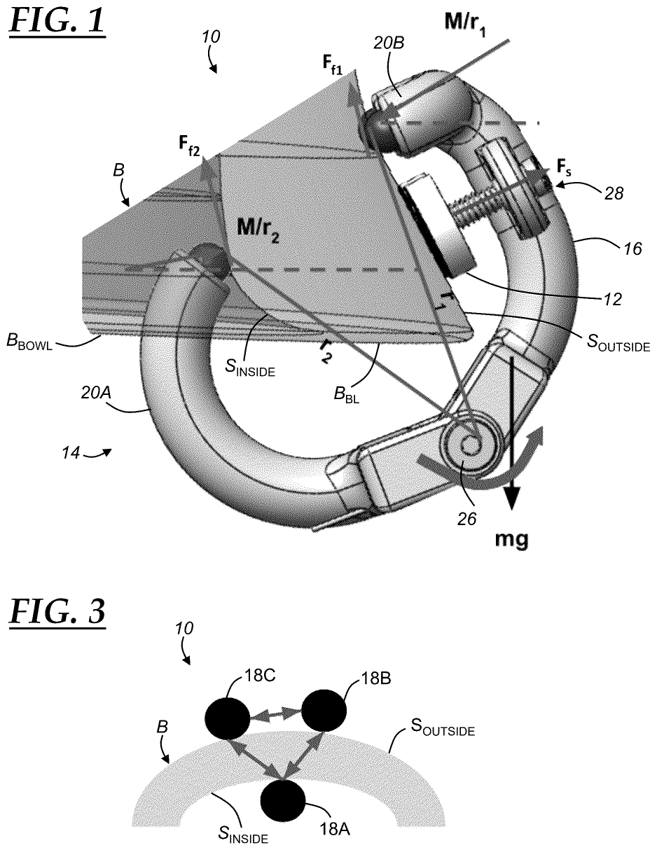

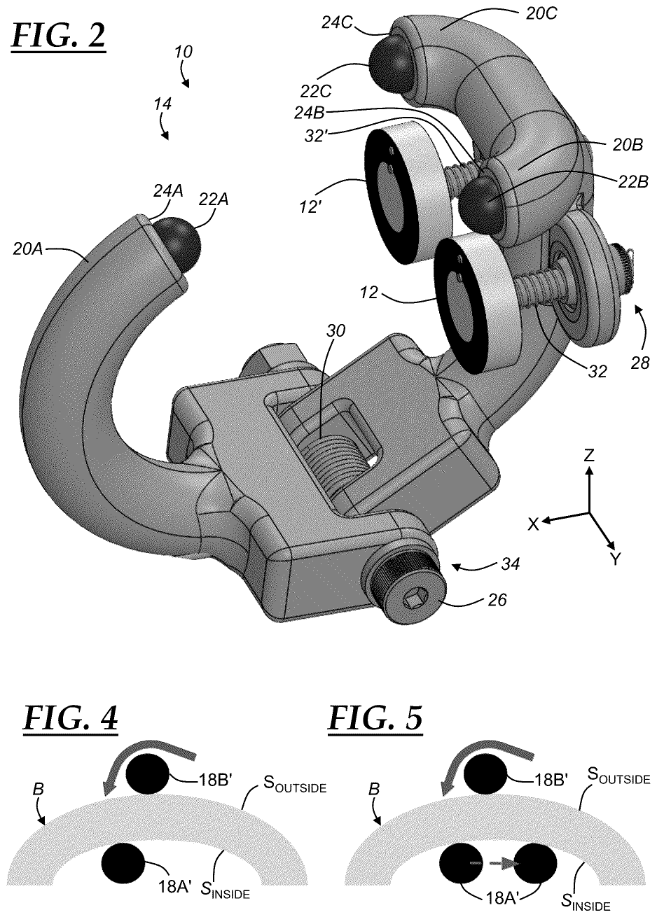

With reference to FIGS. 1-2, there is shown an embodiment of a bell resonator 10 for a bell B, comprising a piezoelectric transducer 12 and a mounting device 14. The mounting device 14 supports the piezoelectric transducer 12 and is configured to attach to the bell B such that the piezoelectric transducer 12 engages a surface S of the bell B so as to vibrate the bell B when the piezoelectric transducer 12 is electrically activated.

The mounting device 14 of the bell resonator 10 includes a clamp 16 configured to attach to the bell B using at least three points of contact 18A-C as illustrated in FIG. 3. The at least three points of contact 18A-C include at least one inside surface S_{INSIDE} of the bell B and at least one outside surface SOUTSIDE of the bell B. As illustrated, in the present embodiment, the clamp 16 is configured to attach to the bell B via two outside surface contact points 18B, 18C and a single inside surface contact point 18A. According to embodiments, the three points of contact 18A-C provide for a more reliable grip than a grip with only two points of contact. FIGS. 4-5 illustrate an embodiment in which only two contact points 18A′, 18B′ contact the bell B including a single contact point 18A′ for contacting the inside surface S_{INSIDE} of the bell B and a single contact point 18B′ for contacting the outside surface SOUTSIDE of the bell B. Use of a three-point contact instead of a two-point contact ensures that the clip grabs the bell surface, achieves equilibrium, and eliminates any side twist and/or movement of the contact points as shown in FIG. 5 by the arrows.

The clamp 16 includes at least three finger grips 20A-C that attach the clamp 16 to the bell B at the at least three points of contact 18A-C. The clamp 16 includes an elastomeric contact surface 22A-C at a distal end 24A-C of each of the three or more finger grips 20A-C. The clamp 16 further comprises a spring-biased pivot connection 26 between at least two of the finger grips 20A-C. According to an embodiment, each of the elastomeric contact surfaces 22A-C is formed via using an elastomeric material, such as rubber and may each be formed of push-in rubber bumpers as shown in the depicted embodiment; however, in other embodiments, a rubber strip may be used in place of or in addition to the rubber bumpers to increase the friction contact area. The elastomeric material as used at the elastomeric contact surface 22A-C improves the grip friction.

According to the present embodiment, the bell resonator 10 further comprises an adjustable transducer positioner 28 that connects the piezoelectric transducer 12 to the mounting device 14. The clamp 16 attaches over a bottom lip B_{BL} of the bell B.

In the illustrate embodiment, the mounting device 14 includes a torsional spring 30 and a compression spring 32. The torsional spring 30 is located at a clamp pivot joint 34 and, in the present embodiment, is configured so that it can overpower the compression spring 32. This ensures that when the clamp 16 grabs the bell B, the compression spring 32 ensures the piezoelectric transducer 12 is in contact with the bell B but is not strong enough to open the clamp so as to disengage the finger grips 20A-C from the surface of the bell B. In the present embodiment, a 315° angle spring is used as the torsional spring 30. This way, the spring must be bent 45° to make the spring arms (connected via the clamp pivot joint 34) parallel to each other. The spring arms at the clamp pivot joint 34 are angled at 135° from each other during closed position which makes the angle 180° thereby providing a higher moment. This angle can change with respect to bell curvature but pre-angular displacement makes sure there is always a moment applied to grab the bell B. The spring constant of the torsional spring is calculated using Equation (1) below. Using that, the applied moment and stress is calculated as shown in Equations (2) and (3).

$$k = {Ed}^{4} / 64 DN \qquad Equation ( 1 )$$

$$M = k θ \qquad Equation ( 2 )$$

$$σ = 32 M / π {d}^{3} \qquad Equation ( 3 )$$

where k is spring constant, E is Young's Modulus, D is average coil diameter, N is number of coils, θ is the angular displacement, M is applied moment, σ is bending stress, and d is diameter of coil material. Using that, the applied moment of the present embodiment was found to be 7.66e-2 Nm and the bending stress was found to be 1100 MPa. Due to high bending stress, springs made with music wire steel may be used, which, according to an embodiment, has a yield stress of 1590 MPa ensuring a safety factor of 1.4.

According to an embodiment, the bell resonator 10 includes a second piezoelectric transducer 12′ that is analogous to the piezoelectric transducer 12 (also referred to as the first piezoelectric transducer 12). The second piezoelectric transducer 12′ is carried by the mounting device 14 such that both transducers 12, 12′ engage a surface S of the bell B so as to vibrate the bell B when the transducers 12,12′ are electrically activated.

In the illustrated embodiment, the mounting device 14 includes two compression springs 32,32′; however, in embodiments, a single compression spring may be used such as where there is one piezoelectric transducer 12. The compression springs 32,32′ are used to ensure contact between piezoelectric transducer 12, 12′ and the bell B. From the moment due to the torsional spring 30, the force at the piezoelectric transducer joint can be calculated. According to the present embodiment, the minimum force required to overcome the force from torsional spring is 2.1N. In the present embodiment, each compression spring 32,32′ is a spring with a spring constant of 50.7N/m. Even if the spring 32,32′ is compressed to its max distance, the compression force is 0.38N, which gives a safety factor of 5.45. This is good as it ensures contact with the bell B but does not overpower the torsional spring 30.

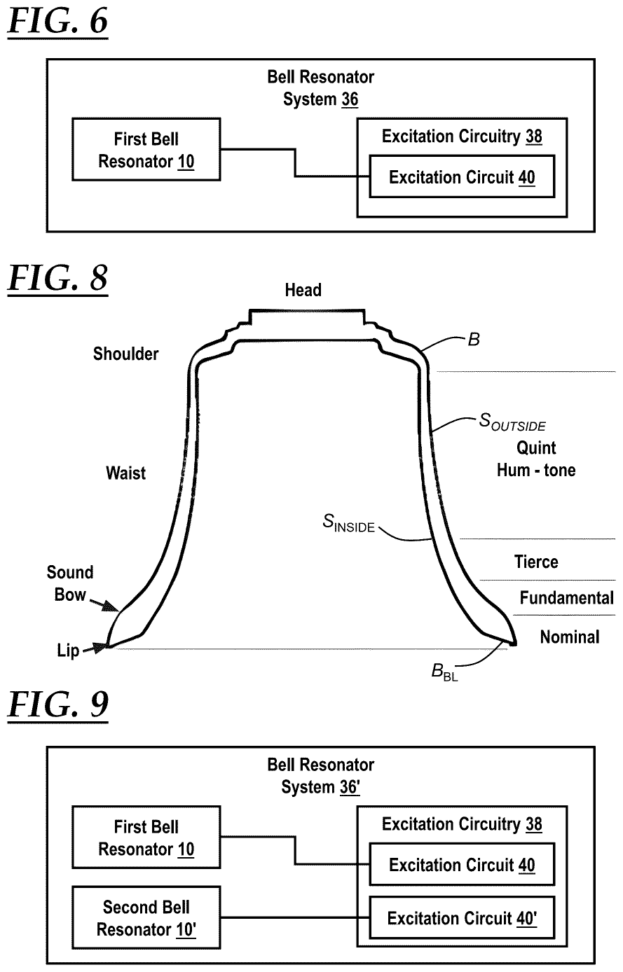

With reference to FIG. 6, there is shown a bell resonator system 36 comprising the bell resonator 10 and excitation circuitry 38 that electrically drives the piezoelectric transducer 12 of the bell resonator 10. The excitation circuitry 38 includes an excitation circuit 40. In embodiments, including the present embodiment, the same excitation circuitry 38 and same excitation circuit 40 is used to drive more than one piezoelectric transducer, such as both piezoelectric transducers 12,12′.

With reference to FIG. 7, there is shown an embodiment of the excitation circuit 40. The excitation circuit 40 is configured to vibrate the bell B via the piezoelectric transducer 12 of the bell resonator 10 at a resonant frequency of the bell B.

Experimentation and testing was done involving driving disks of the piezoelectric transducers 12,12′ using benchtop function generators. Using several of these large and expensive machines is not practical when attaching multiple devices to different bells, at least in embodiments. Additionally, a solution that can be automatically tuned to excite several harmonic and partial harmonic frequencies at different amplitudes is preferable, according to embodiments. Microcontrollers and op amp circuits that generate signals with a greater level of control and more compact packaging may be used. In the present embodiment, the system 36 is designed based on the voltage requirements of piezoelectric transducers 12,12′ (and their discs) and the Nyquist frequency necessary for bell frequency identification.

The benchtop function generator does two main jobs: generating a sinusoidal signal and supplying power to the piezoelectric transducers 12,12′. To achieve similar functionality, both of these are used such that the system 36 consists of a microcontroller 42 and a separate power supply. However, a 30 Vpp signal from the microcontroller 42 is obtained so an op amp (Operational amplifier) circuit 44 is used. The op amp circuit 44 receives an analog waveform from the microcontroller 42 and amplifies that signal. Getting a 30V power supply is achievable but often inconvenient. Therefore, in embodiments, a boost module 46 is used to convert a 5V voltage to a 30V. In the present embodiment, the op amp circuit 44 will use this as an input voltage to amplify the signal. The gain from the op amp circuit 44 can be controlled manually by a potentiometer 48. This potentiometer 48 can be implemented in the end user interface to control the amplitude of the bell B. The boosted voltage waveform from the op amp circuit 44 energizes the piezoelectric transducer 12,12′ to excite the bell B.

A notable concern when choosing the microcontroller 42 was ensuring the Nyquist Frequency Theorem would be met. The theorem states that the sampling frequency of the device must be at least two times the largest frequency of the signal you will be sampling, which can be seen below in Equation (4), where fₛ is the sampling frequency and fₘ is the maximum sampled frequency.

$${f}_{s} = 2 * {f}_{m} \qquad Equation ( 4 )$$

Based on data collected during testing of the present embodiment, the highest frequency that is considered is approximately 9012.3 Hz for the fourth harmonic on the bell B. Therefore, at least according to the present embodiment, minimum sampling frequency would need to be about 18 kHz; however, increasing the requirement may be done to ensure no data is lost; for example, in one embodiment, the sampling frequency is increased to three times the maximum signal frequency, bringing the requirement to about 27 kHz, which exceeds the capabilities of a standard Arduino Uno™. Therefore, in one embodiment, the ESP32-WROVER™ is used as the microcontroller 42, which has an analog-to-digital converter (ADC) sampling frequency of up to 27 kHz and a digital-to-analog converter (DAC) signal frequency up to 44.1 KHz. Also, an analog signal was supplied in the present embodiment. Arduino™ can produce an analog signal using pulse-width modulation (PWM). However, at least in embodiments, it will not be a continuous analog signal. In addition, the ESP32-WROVER™ has continuous DAC modes, Wi-Fi™ and Bluetooth™ capabilities, and better processing power than Arduino™, making it preferable in some embodiments.

In the present embodiment, the op amp circuit 44 was selected to be an OPA551PA based on the voltage range of the boost converter 46 and low distortion capability during amplification. This op amp circuit 44 can handle varying voltage from 4V to 30V and supply current up to 200 mA. Additionally, this op amp circuit 44 meets specifications of the present system 36 for low-temperature operation. In the present embodiment, the op amp circuit 44 is also fully thermal protected and limits the output current to protect the circuit from any sudden spikes. Also, it has a fast slew rate of 15e6 V/s (change in output voltage over time) and high bandwidth of 3 Mhz that ensures fast and accurate signal amplification.

In the present embodiment, the boost module 46 is selected to be a HiLetgo XL6009™ based on the voltage requirements of the discs of the piezoelectric transducers 12,12′. In embodiments, piezoelectric discs have a voltage range of 30 Vpp, so the boost converter 46 is selected with a high voltage range of up to 35V. The 3 A output current of the boost converter 46 also means that many piezoelectric transducers 12,12′ can be powered simultaneously. Additionally, this boost converter 46 of the present embodiment was selected for its low operating temperatures to help meet cold temperature specifications. Also, this boost module 46 of the present embodiment has a built-in potentiometer that helps to lower the voltage if desired.

In the present embodiment, the dedicated digital-to-analog pin GPIO25 or GPIO26 on the ESP32 (microcontroller 42) is used. ESP32 can create a sinusoidal signal 0 to 3.3V. Then, the signal goes through a 10 kΩ resistor to protect the downward circuit from sudden unintentional spikes from the microcontroller 42. In the present embodiment, the op amp circuit 44 is used as a non-inverting op amp configuration. The gain of the op amp circuit 44 is controlled by the 47 kΩ (potentiometer 48 using as shown in Equation (5).

$$Gain , A ( v ) = 1 + \frac{{R}_{1}}{{R}_{2}} \qquad Equation ( 5 )$$

where R₁ and R₂ are resistance values that are controlled by the potentiometer 48. For example, a ratio of R₁/R₂=3.7 (R₁=37 kΩ, R₂=10 kΩ) gives a gain of 4.7. This converts the 3.3V signal to a 15V signal. The boost module 46 supplies power to the op amp circuit 44.

According to embodiments, the spring constants and the range of motion in the torsion spring 30 are more limited, and so a material that has a high coefficient of friction for the contact points may be selected. In embodiments, a torsion spring that fits around a ¼ inch diameter shoulder bolt and is smaller than ½ inch long is selected to limit the presence of the bell resonator 10 by decreasing its size but still maintaining structural integrity. In embodiments, springs in this smaller size range may be made of music wire steel as this allows selection of a spring that can provide a larger angle of deflection without it breaking. In embodiments, either a 315° or 360° torsion spring is used to maximize or otherwise increase the forces at the contact points on the bell resonator 10. From these torsion spring limitations, it was found the highest spring constant of 1.1 lb/in to be available and it is also a 315° torsion spring, according to the present embodiment.

According to the present embodiment, the dimensions of the bell resonator 10 are approximately 2 inches wide (in the Y-direction), 2.5 inches tall (in the Z-direction), and 3 inches long (in the X-dimension). FIG. 2 depicts a design of the bell resonator 10 according to the present embodiment. When looking at the contact points 18A-C, rubber-to-bronze is chosen as it gives a value of 0.7-0.9 for the coefficient of static friction, and the range depends on the texture and hardness of the rubber. In the present embodiment, for the swivel joints that the piezoelectric transducers 12,12′ are connected by, a corrosion resistant swivel joint was selected that has a ±9° range of motion from the non-perturbed orientation. Having this freedom for the piezoelectric transducers 12, 12′ ensures that the efficiency of energy transfer from the piezoelectric transducers 12,12′ to the bell B is high, according to the present embodiment.

From visual inspection, the thickness of the bell B decreases as it goes away from the lip of the bell B and past the nominal frequency zone as is illustrated in FIG. 8. This may cause the bell resonator 10 to drive up the bell B as it tries to reach a lower energy state from having the torsion spring 30 reach a smaller angular displacement. In embodiments, if the coefficient of friction is not great enough such that the bell resonator 10 drives up the bell, a stopper may be attached to the piezoelectric transducers 12, 12′ or one of the components of the mounting device 14 to ensure that the piezoelectric transducers 12, 12′ stay at the fundamental zone that have experienced the greatest excitation.

The table below shows a bill of materials that may be used for the bell resonator 10, according to embodiments.

TABLE 1

| | | |
|---|---|---|
| Item | Vendor | Part Number |

Electrical Components

| | | |
|---|---|---|
| 20 mm Piezo disc | Amazon ™ | |
| ESP32 Wrover | Amazon ™ | |
| Boost Converter | Amazon ™ | XL6009 |
| OP amp | Texas | OPA551PA |
| | Instruments ™ | |
| Potentiometer | Amazon ™ | |
| Circuit Board | Amazon ™ | |

Mechanical Components

| | | |
|---|---|---|
| Compression Spring | McMaster-Carr ™ | 9657K81 |
| Swivel Joint | McMaster-Carr ™ | 63215K22 |
| 6-32 316 Shoulder Bolt ⅝″ length | McMaster-Carr ™ | 97345A114 |
| Rubber Push in Bumpers | McMaster-Carr ™ | 9309K93 |
| 315 Degree Torsion Spring | McMaster-Carr ™ | 9271K731 |
| 10-24 316 Shoulder Bolt 1⅝″ length | McMaster-Carr ™ | 97345A169 |
| Clamp jaw | 3D printed | |
| Piezo grabber | 3D printed | |

Bell Stand

| | |
|---|---|
| ⅞ bolt | Carpenter Bros ™ |
| ⅞ lock nut | Carpenter Bros ™ |
| Rubber washer | Carpenter Bros ™ |
| 2 × 1 Aluminum rectangle tube | MetalsDepot ™ |

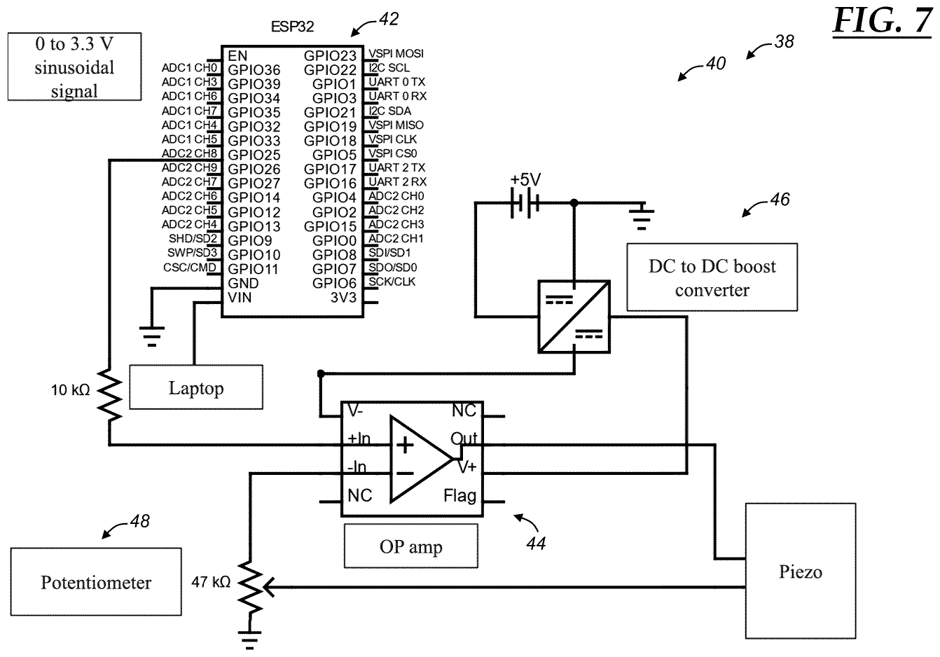

With reference to FIG. 9, there is shown a bell resonator system 36′ comprising the bell resonator 10 (as a first bell resonator 10) and a second bell resonator 10′. In embodiments employing more than one bell resonator, each bell resonator is driven by a separate excitation circuit 40,40′ of the excitation circuitry 38; however, in other embodiments, each bell resonator 10,10′ is driven by the same excitation circuit 40.

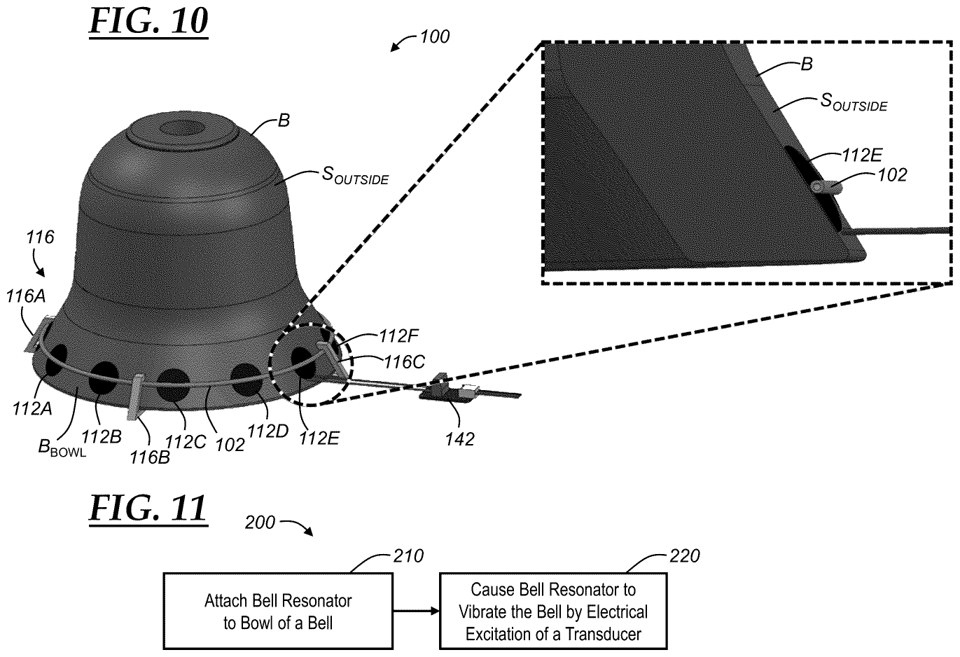

With reference to FIG. 10 and according to another embodiment, a bell resonator 100 having a distributed piezo band design is provided. This bell resonator 100 includes a plurality of piezoelectric transducers (piezos) 112 spaced equally about the bell B and held onto the surface S of the bell B with a mounting device 114 having an elastic band 102. The piezoelectric transducers 112 correspond to the piezoelectric transducers 12 described above. The excitation circuitry 38 described above may be used for controlling the piezoelectric transducers 112. In the present embodiment, the piezoelectric transducers 112 are connected in series and are controlled via a microcontroller 142, which may be the same microcontroller 42 as discussed above.

The plurality of piezoelectric transducers 112 in the present embodiment includes twelve (12) piezoelectric transducers, six of which are shown in FIG. 10 as piezoelectric transducers 112A-F. Each of the plurality of piezoelectric transducers 112 are attached to the outside surface SOUTSIDE of the bell B via a mounting device 114. The mounting device 114 includes an elastic band 102 and a plurality of clips 116 that prevent the piezoelectric transducers 112 from slipping up the conical outside surface SOUTSIDE of the bell B as shown in FIG. 10. The plurality of clips 116 includes four clips in the present embodiment, three of which are shown in FIG. 10 as clips 116A-C. In the present embodiment, the use of the clips 116 help keep the elastic band 102 and the piezoelectric transducers 112 at the fundamental frequency zone of the bell B.

In the present embodiment, out of plane piezo motion may be used to apply force on the bell B. Amplitude can be controlled by adjusting the voltage of the signal. This could also be controlled by the gain in the control system (the excitation circuitry 38). According to the present embodiment, this design is fairly scalable as it can use different sizes of bands with more or less piezoelectric transducers 112 to accommodate the energy requirements of different bells. Further, according to the present embodiment, this piezoelectric design is also very lightweight compared to the bell mass, so bell frequency should be minimally affected.

According to embodiments, some advantages of this design include cost-effectiveness and the relative simplicity of the design. Also, at least in some embodiments, this design is easily scalable to bigger bells as it is readily configurable to have more piezoelectric transducers 112 and a bigger elastic band 102 to adapt it to that bell. Using clips will help keep the piezo band at the fundamental frequency zone.

With reference to FIG. 11, there is shown a method 200 of producing sound from a bell, such as the bell B described above. The method 200 begins with step 210, wherein a bell resonator is attached to a bowl of a bell. In one embodiment, the bell resonator 10 is attached to the bowl B_{BOWL} of the bell B. In another embodiment, the bell resonator 100 is attached to the bowl B_{BOWL} of the bell B. And, in other embodiments, other mechanisms for attaching the bell resonator to the bowl B_{BOWL} of the bell B may be used, such as, for example, electrical tape in place of the clips 116 of the bell resonator 100. The method 200 continues to step 220.

In step 220, the bell resonator 10 is caused to vibrate the bell B by electrical excitation of a transducer that is in contact with a surface of the bell. In one embodiment, the piezoelectric transducer(s) 12,12′ of the bell resonator 10 are electrically activated so as to cause the bell B to vibrate. In another embodiment, the piezoelectric transducers 112 of the bell resonator 100 are electrically activated so as to cause the bell B to vibrate. The method 200 ends.

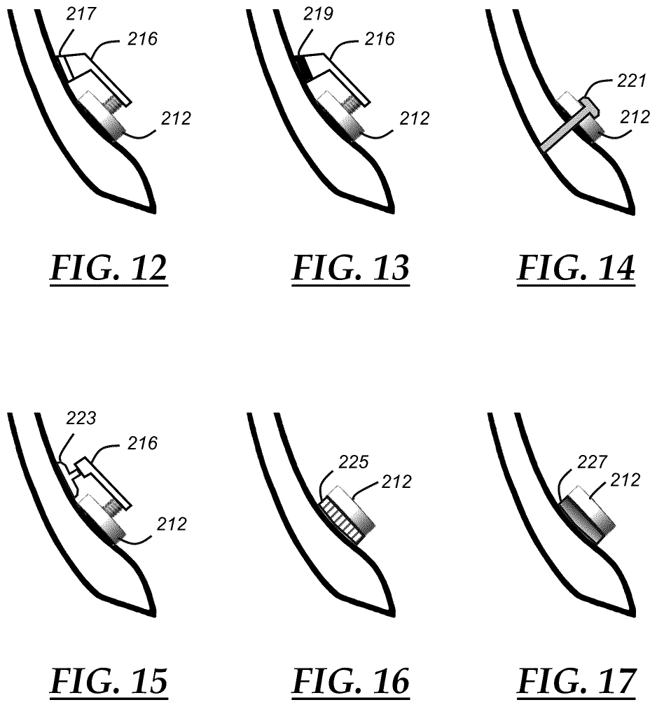

Those skilled in the art will appreciate that, other than the clamp 16, band 102, and clips 116 illustrated and described herein, any of a number of other mounting devices may be used. Examples of other mounting devices for a transducer 212 are depicted diagrammatically in FIGS. 12-17, including a bracket 216 having an adhesive layer or other member 217, a bracket 216 having a magnet 219, a fastener 221, and a bracket 216 having a suction cup 223. Many other such approaches for mounting the transducer 212 will become apparent to those skilled in the art. In this regard, the mounting device in some embodiments may be physically located between the transducer 212 and bell, such as shown in FIGS. 16 and 17 wherein the mounting device comprises a magnet 225 or adhesive member 227, respectively.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A bell resonator for a bell, comprising a piezoelectric transducer and a mounting device, the mounting device supporting the piezoelectric transducer and being configured to attach to a bell such that the piezoelectric transducer engages a surface of the bell so as to vibrate the bell when the piezoelectric transducer is electrically activated.

2. The bell resonator set forth in claim 1, wherein the mounting device comprises a clamp configured to attach to the bell using at least three points of contact that include at least one inside surface of the bell and at least one outside surface of the bell.

3. The bell resonator set forth in claim 2, wherein the clamp includes at least three finger grips that attach the clamp to the bell at the at least three points of contact.

4. The bell resonator set forth in claim 3, wherein the clamp further comprises a spring-biased pivot connection between at least two of the finger grips.

5. The bell resonator set forth in claim 3, wherein the clamp includes an elastomeric contact surface at a distal end of each of the three or more finger grips.

6. The bell resonator set forth in claim 5, wherein the clamp further comprises a spring-biased pivot connection between at least two of the finger grips.

7. The bell resonator set forth in claim 1, further comprising an adjustable transducer positioner that connects the piezoelectric transducer to the mounting device.

8. The bell resonator set forth in claim 1, wherein the clamp attaches over a bottom lip of the bell.

9. The bell resonator set forth in claim 1, further comprising a second piezoelectric transducer carried by the mounting device such that both piezoelectric transducers engage a surface of the bell so as to vibrate the bell when the piezoelectric transducers are electrically activated.

10. The bell resonate set forth in claim 1, wherein the mounting device comprises at least one clamp, adhesive member, magnetic fixture, band, bracket, clip, suction cup, and/or fastener.

11. A bell resonator system, comprising one or more bell resonators according to claim 1, and an excitation circuit that electrically drives the piezoelectric transducer(s).

12. The bell resonator system of claim 11, wherein the excitation circuit is configured to vibrate the bell via the piezoelectric transducer(s) at a resonant frequency of the bell.

13. The bell resonator system set forth in claim 11, wherein the bell resonator comprises one of plurality of bell resonators attached to the bell at spaced locations about a circumference of the bell at or adjacent a sound bow of the bell.

14. The bell resonator system set forth in claim 13, wherein the excitation circuit comprises one of a plurality of excitation circuits, and wherein each of the bell resonators includes a separate one of the plurality of excitation circuits.

15. A method of producing sound from a bell, comprising:
attaching a bell resonator to a bowl of the bell; and
causing the bell resonator to vibrate the bell by electrical excitation of a transducer of the bell resonator that is in contact with a surface of the bell.

16. The method set forth in claim 15, wherein the bell resonator is attached to the bowl of the bell via a mounting device, and wherein the mounting device comprises a clamp configured to attach to the bell using at least three points of contact that include at least one inside surface of the bell and at least one outside surface of the bell.

17. The method set forth in claim 16, wherein the clamp includes at least three finger grips that attach the clamp to the bell at the at least three points of contact.

18. The method set forth in claim 17, wherein the clamp further comprises a spring-biased pivot connection between at least two of the finger grips.

19. The method set forth in claim 17, wherein the clamp includes an elastomeric contact surface at a distal end of each of the three or more finger grips.

20. The method set forth in claim 16, wherein the clamp attaches over a bottom lip of the bell.

21. The method set forth in claim 15, wherein the bell resonator is attached to the bowl of the bell via a mounting device, and wherein the bell resonator further comprises an adjustable transducer positioner that connects the transducer to the mounting device.

22. The method set forth in claim 15, wherein the transducer is a first piezoelectric transducer and wherein the bell resonator further comprises a second piezoelectric transducer carried by the mounting device such that both piezoelectric transducers engage a surface of the bell so as to vibrate the bell when the piezoelectric transducers are electrically activated.

23. A bell resonator for a bell, comprising:
a piezoelectric transducer; and
a mounting device supporting the piezoelectric transducer and being configured to attach to a bell by any of: a clamp, adhesive member, magnetic fixture, band, bracket, clip, suction cup, fastener, or a combination thereof, such that the piezoelectric transducer engages a surface of the bell so as to vibrate the bell when the piezoelectric transducer is electrically activated.
